(19) United States
(12) Patent Application Publication
(10) Pub. No.: US 2005/0255295 A1
(43) Pub. Date: Nov. 17, 2005

(54) Slat structure for venetian blind

(76) Inventor: Ker-Min Lin, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/847,265

(22) Filed: May 16, 2004

(51) Int. Cl. E06B 3/48

(52) U.S. Cl. 428/166; 428/188

(57) ABSTRACT

A slat structure includes a slat body having an inside formed with a plurality of channels. Thus, the material of the slat structure is greatly reduced by provision of the channels of the slat body, thereby decreasing costs of fabrication of the slat structure. In addition, the total weight of the slat structure is greatly reduced by provision of the channels of the slat body, thereby facilitating package, transportation and assembly of the slat structure. Further, the channels of the slat structure efficiently isolate the source of heat and noise, thereby providing an insulating and noise depression effect.

### BACKGROUND OF THE INVENTION

1. Field of the Invention

The present invention relates to a slat structure, and more particularly to a slat structure for a Venetian blind.

2. Description of the Related Art

A conventional slat structure 3 in accordance with the prior art shown in FIG. 6 is available for a Venetian blind (not shown) to provide a shield effect. However, the conventional slat structure 3 is made of a solid sheet plate that cannot efficiently isolate the source of heat and noise, thereby decreasing the insulating and noise depression effect.

### SUMMARY OF THE INVENTION

In accordance with the present invention, there is provided a slat structure, comprising:
a slat body having an inside formed with a plurality of channels.

Preferably, the slat body is formed by a plastic extruding process and has a thickness of about 1 mm to 5 mm.

The primary objective of the present invention is to provide a slat structure for a Venetian blind, vertical blind or the like.

Another objective of the present invention is to provide a slat structure, wherein the material of the slat structure is greatly reduced by provision of the channels of the slat body, thereby decreasing costs of fabrication of the slat structure.

A further objective of the present invention is to provide a slat structure, wherein the total weight of the slat structure is greatly reduced by provision of the channels of the slat body, thereby facilitating package, transportation and assembly of the slat structure.

A further objective of the present invention is to provide a slat structure, wherein the total weight of the slat structure is reduced, so that the burden applied on the support cords of the Venetian blind is reduced, thereby enhancing the lifetime of the Venetian blind.

A further objective of the present invention is to provide a slat structure, wherein the channels of the slat structure efficiently isolate the source of heat and noise, thereby providing an insulating and noise depression effect.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away perspective view of a slat structure in accordance with the preferred embodiment of the present invention;

FIG. 2 is a partially cut-away perspective view of a slat structure in accordance with another embodiment of the present invention;

FIG. 3 is a plan view of a slat structure in accordance with another embodiment of the present invention;

FIG. 4 is a perspective view showing the slat structure being mounted on a Venetian blind;

FIG. 5 is a perspective view showing the slat structure being mounted on a vertical blind; and

FIG. 6 is a perspective view of a conventional slat structure in accordance with the prior art

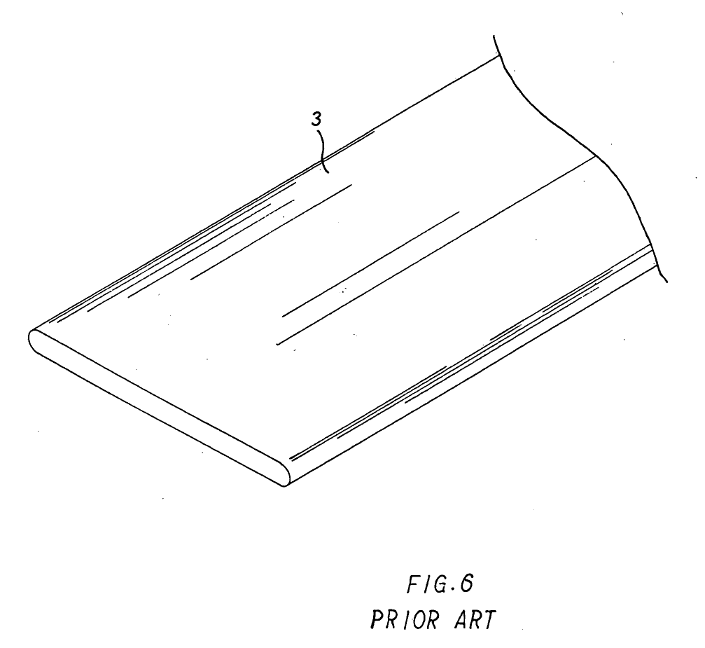

### DETAILED DESCRIPTION OF THE INVENTION

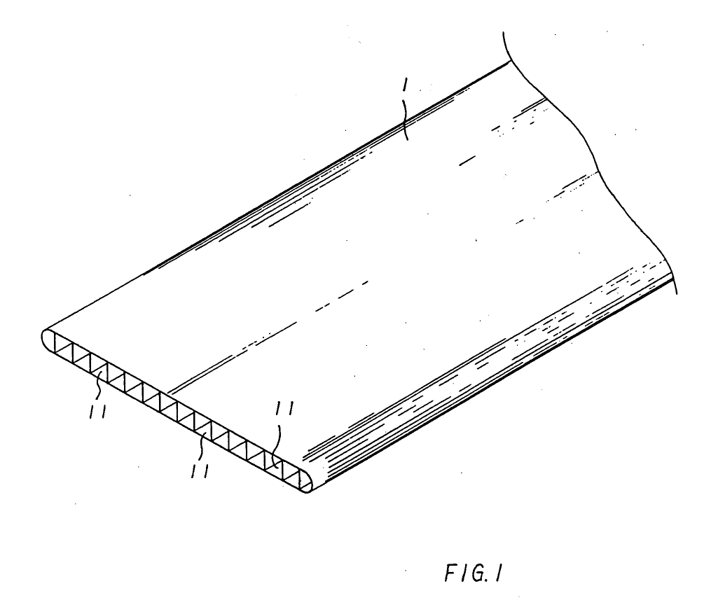

Referring to the drawings and initially to FIGS. 1-3, a slat structure in accordance with the preferred embodiment of the present invention comprises a slat body 1 having an inside formed with a plurality of channels 11. The channels 11 of the slat body 1 are extended longitudinally through a whole length of the slat body 1. The slat body 1 is a planar plate formed by a plastic extruding process. The slat body 1 has a thickness of about 1 mm to 5 mm.

As shown in FIG. 1, each of the channels 11 of the slat body 1 has a triangular shape.

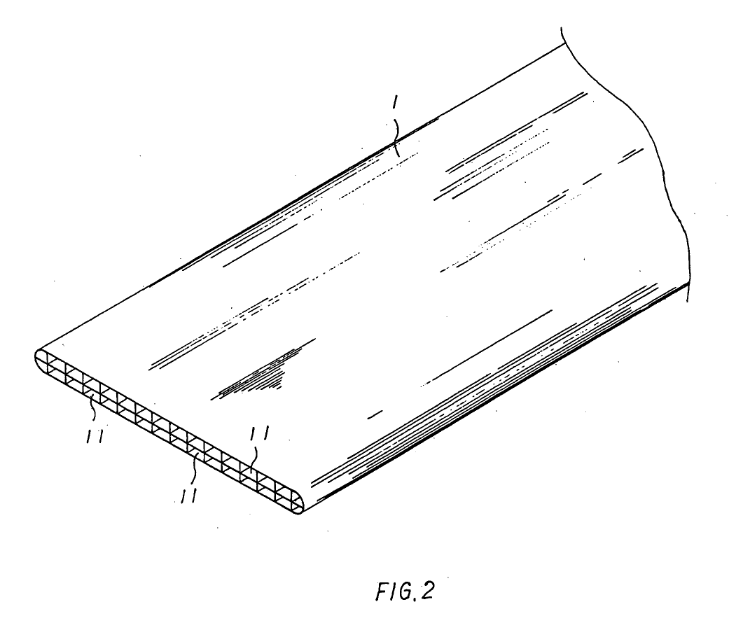

As shown in FIG. 2, the channels 11 of the slat body 1 laminate each other.

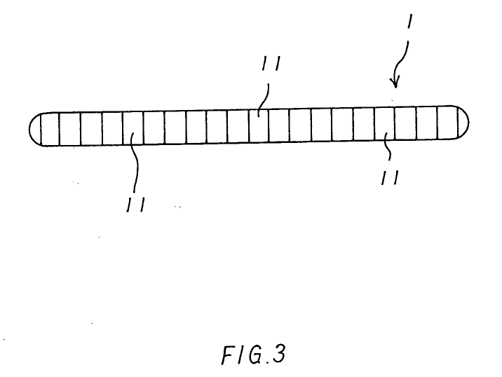

As shown in FIG. 3, each of the channels 11 of the slat body 1 has a rectangular shape.

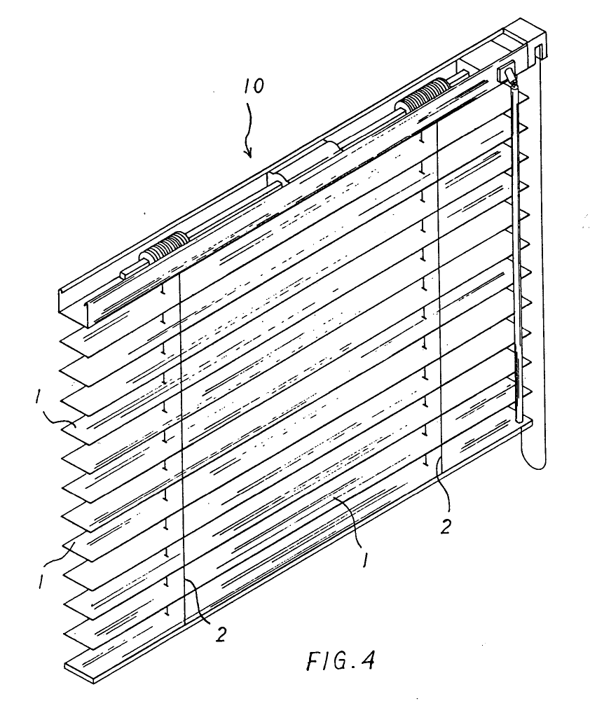

As shown in FIG. 4, the slat structure is available for a Venetian blind 10 having support cords 2 for supporting the slat body 1 of the slat structure.

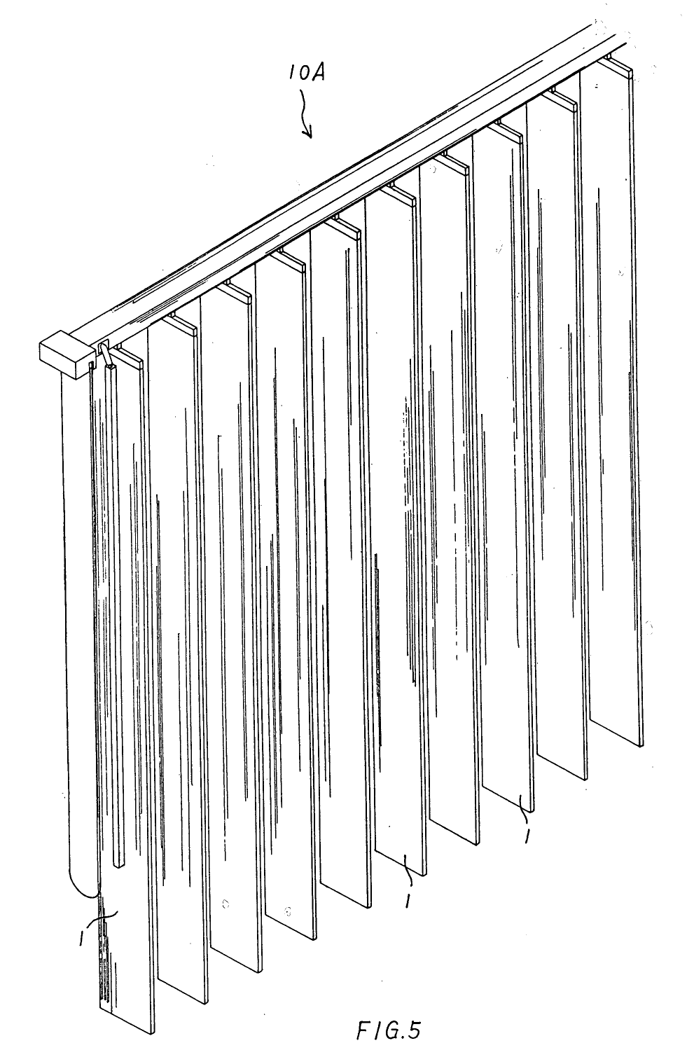

As shown in FIG. 5, the slat structure is available for a vertical blind 10A.

Accordingly, the material of the slat structure is greatly reduced by provision of the channels 11 of the slat body 1, thereby decreasing costs of fabrication of the slat structure. In addition, the total weight of the slat structure is greatly reduced by provision of the channels 11 of the slat body 1, thereby facilitating package, transportation and assembly of the slat structure. Further, the total weight of the slat structure is reduced, so that the burden applied on the support cords 2 of the Venetian blind 10 is reduced, thereby enhancing the lifetime of the Venetian blind 10. Further, the channels 11 of the slat structure efficiently isolate the source of heat and noise, thereby providing an insulating and noise depression effect.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A slat structure, comprising:
a slat body having an inside formed with a plurality of channels.

2. The slat structure in accordance with claim 1, wherein the channels of the slat body are extended longitudinally through a whole length of the slat body.

3. The slat structure in accordance with claim 1, wherein the slat body is a planar plate.

4. The slat structure in accordance with claim 1, wherein the slat body is formed by a plastic extruding process.

5. The slat structure in accordance with claim 1, wherein the slat body has a thickness of about 1 mm to 5 mm.

6. The slat structure in accordance with claim 1, wherein each of the channels of the slat body has a triangular shape.

7. The slat structure in accordance with claim 1, wherein the channels of the slat body laminate each other.

8. The slat structure in accordance with claim 1, wherein each of the channels of the slat body has a rectangular shape.
